(19) United States
(12) Patent Application Publication
(10) Pub. No.: US 2025/0047164 A1
(43) Pub. Date: Feb. 6, 2025

(54) HANDHELD CULTIVATOR

(71) Applicant: Techtronic Cordless GP, Anderson, SC (US)

(72) Inventors: Jin Cheng Li, Dongguan City (CN); Zheng Jun Wang, Dongguan City (CN); Dong Wei Li, Dongguan City (CN); Hai Yu Xu, Dongguan City (CN)

(21) Appl. No.: 18/570,972

(22) PCT Filed: Jun. 16, 2021
(86) PCT No.: PCT/CN2021/100371

§ 371 Date: Dec. 15, 2023

(51) Int. Cl. H02K 5/20; A01B 1/06; A01B 1/10; B25F 5/00; F04D 17/00; F04D 25/06; H02K 5/18; H02K 7/14; H02K 9/06

(52) U.S. Cl. CPC H02K 5/207; A01B 1/065; A01B 1/10; B25F 5/008; F04D 17/00; F04D 25/0673; H02K 5/18; H02K 7/145; H02K 9/06

(57) ABSTRACT

Improved cooling systems for handheld devices are disclosed. In some aspects, the cooling system may utilize air inlets disposed behind a guard to prevent debris or liquids from entering the handheld device and potentially causing damage to internal components of the handheld device. In aspects, a vents may be disposed on the guard to divert cooling air into a housing of the handheld device to cool internal components, such as the motor or a printed circuit board (PCB). In additional or alternative aspects, a motor mount may be provided that includes ribs defining air channels to divert or direct cooling air to components to be cooled. The air channels provided by the motor mount may enable the cooling air to reach portions of the internal components that may be distant from the air inlets of the housing.

### CROSS-REFERENCE TO RELATED APPLICATIONS

The present application claims the benefit of priority to International Patent Application No. PCT/CN2021/100371, filed Jun. 16, 2021, and entitled “Handheld Cultivator,” the disclosures of which are incorporated by reference herein in their entirety.

### TECHNICAL FIELD

The present invention relates generally to handheld electrical devices and more specifically to cooling systems for handheld electrical devices.

### BACKGROUND OF THE INVENTION

Electric cultivators, such as mini tillers, are widely used by farmers and homeowners for cultivating the soil in land or a garden. These electric cultivators are generally compact, light-weight, and portable A typical electric cultivator often includes a handle, a battery pack, a motor, one or more tine discs, and gears for driving a drive shaft in mechanical communication with the motor and one or more tine discs to drive rotation of the tine disc(s) (e.g., for digging into the ground to penetrate and pulverize the soil). Handheld electric cultivators are typically utilized to cultivate the top layer of the soil and may be particularly useful for ornamental landscaping of small gardens or other small areas where conditioning of the soil via tilling may be desired. The electric motor of typical electric cultivators generates heat during use. This heat must be adequately dissipated to avoid damage to the motor or other components of the cultivator, such as a printed circuit board (PCB).

### BRIEF SUMMARY OF THE INVENTION

Embodiments of the present disclosure provide improved cooling systems for handheld electronic devices, such as a handheld cultivator or tiller. Such handheld devices may include a motor, PCB, electronics or circuitry, or other components which may be disposed within a housing. The housing may be intended to protect such internal components from damage that may be caused by foreign materials, debris, or liquids that may be encountered during operation of the handheld device. For example, a handheld cultivator may kick up dirt, rocks, or liquids as it is used to till or cultivate soil. If such debris or liquids enter the housing they may become lodged in mechanical components of the handheld device, such as the motor or a driveshaft, resulting in damage to the motor, driveshaft, or other components. Similarly, if liquid enters the housing it may cause metal components (e.g., the motor, the driveshaft, etc.) to rust or short circuit electrical systems of the handheld device. A guard (e.g., a plate extending outward from the housing) may be provided to minimize the likelihood that debris or liquids enter the housing and to protect the user. However, operation of the handheld device may produce heat that, if left unaddressed, may also cause damage to the internal components of the handheld device, such as the motor or PCB. Therefore, handheld electronic devices require an ability to cool internal components while simultaneously minimizing the likelihood that debris or liquids enter the housing.

According to the present disclosure, the cooling system of a handheld device may include air inlets disposed on the housing. At least some of the air inlets may be in fluid communication with a protected air channel (e.g., an air channel that is configured to prevent debris, liquids, or other materials from entering the housing). A fan may be disposed within the housing to draw cooling air into the housing, and preferably to the protected air channel(s) to direct the flow of the cooling air towards components to be cooled within the handheld device. According to embodiments, the air inlets may be disposed behind the guard. In some aspects, an air intake extension may be utilized to draw cooling air into the housing from a position behind the guard (or disposed on the guard) and then deliver the cooling air to components within the housing that are at least partially positioned in front of the guard (e.g., components positioned within the housing at least partially between the guard and a working tool). In addition to providing air inlets to draw the cooling air into the housing, one or more air outlets may be provided on the housing and positioned behind the guard. Positioning the air inlets and outlets behind the guard may prevent or minimize the chances that debris or liquids enter the housing during operation of the handheld device.

In some aspects, one or more of the air inlets may be provided via an aperture disposed on the housing and a corresponding vent disposed on the guard (i.e., a guard air intake). In some aspects, the vent(s) and a corresponding air inlet of the housing may be aligned such that cooling air may be drawn into the housing via the vent and the corresponding air inlet aperture of the housing. The vent may be disposed on a side of the guard that faces away from the direction from which debris or liquids may be kicked up during operation of the handheld device. In some aspects, the vent(s) may not be aligned with the air inlet(s) of the housing and an air intake extension may be used to transport the cooling air to the air inlet via the vent. In some aspects, a motor mount may be provided to control or direct air flow as the cooling air is drawn into the housing. For example, the motor mount may include ribs that extend longitudinally along the length of the motor. Pairs of ribs may form protected air channels through which the cooling air may be directed to particular interior spaces of the housing to control cooling of the handheld device, such as to cool an electric motor or PCB of the handheld device, such as to direct the cooling air towards air intake apertures of the motor. Cooling systems of the present disclosure may utilize protected air channels provided by the inlet and vent pairs and/or the plurality of ribs individually or in combination in order to enhance the cooling of the handheld device, such as to cool an electric motor or PCB of the handheld device.

In addition to improving cooling effects, the disclosed cooling systems may also enable more flexibility with respect to manufacturing handheld devices. For example, the protected air channels provided by embodiments may enable the air inlets of the housing to be disposed at a distance from the motor and yet still provide sufficient cooling of the motor (or PCB) by directing the air flow. Additionally, the protected air channels utilizing the plurality of ribs and/or the vent/inlet pairs may enable the motor to be placed closer to a front end of the handheld device, which may enable handheld devices to be constructed with a smaller form factor (and reduced cost) and/or with a balance that may provide more comfort to the user during operation (e.g., disposing the motor closer to the front of the handheld device may create a natural downward tilt when the handheld device is in use, resulting in a more comfortable mode of operation for the user)

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows a side view of a handheld electronic device having a cooling system in accordance with aspects of the present disclosure;

FIG. 2 shows another side view of a handheld electronic device having a cooling system in accordance with aspects of the present disclosure;

FIG. 3 shows a top view of a handheld electronic device having a cooling system in accordance with aspects of the present disclosure;

FIG. 4 shows a bottom view of a handheld electronic device having a cooling system in accordance with aspects of the present disclosure,

FIG. 5 shows a perspective view of a handheld electronic device having a cooling system in accordance with aspects of the present disclosure;

FIG. 6 shows a front view of a handheld electronic device having a cooling system in accordance with aspects of the present disclosure;

FIG. 7 shows a back or rear view of a handheld electronic device having a cooling system in accordance with aspects of the present disclosure;

FIG. 8 shows another perspective view of a handheld electronic device having a cooling system in accordance with aspects of the present disclosure;

FIG. 9 shows a partial view of a handheld electronic device having a cooling system in accordance with aspects of the present disclosure;

FIGS. 10A-10E show additional partial views of a handheld electronic device having a cooling system in accordance with aspects of the present disclosure;

FIGS. 11A-11B show perspective views of motor for a handheld electronic device having a cooling system in accordance with aspects of the present disclosure;

FIG. 12A shows a perspective view of a motor mount providing enhanced cooling of a handheld electronic device in accordance with aspects of the present disclosure;

FIG. 12B shows a partial view of a motor mount providing enhanced cooling of a handheld electronic device in accordance with aspects of the present disclosure; and

FIGS. 13A-13H show partial views of a cooling system for a handheld electronic device in accordance with aspects of the present disclosure.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION OF THE INVENTION

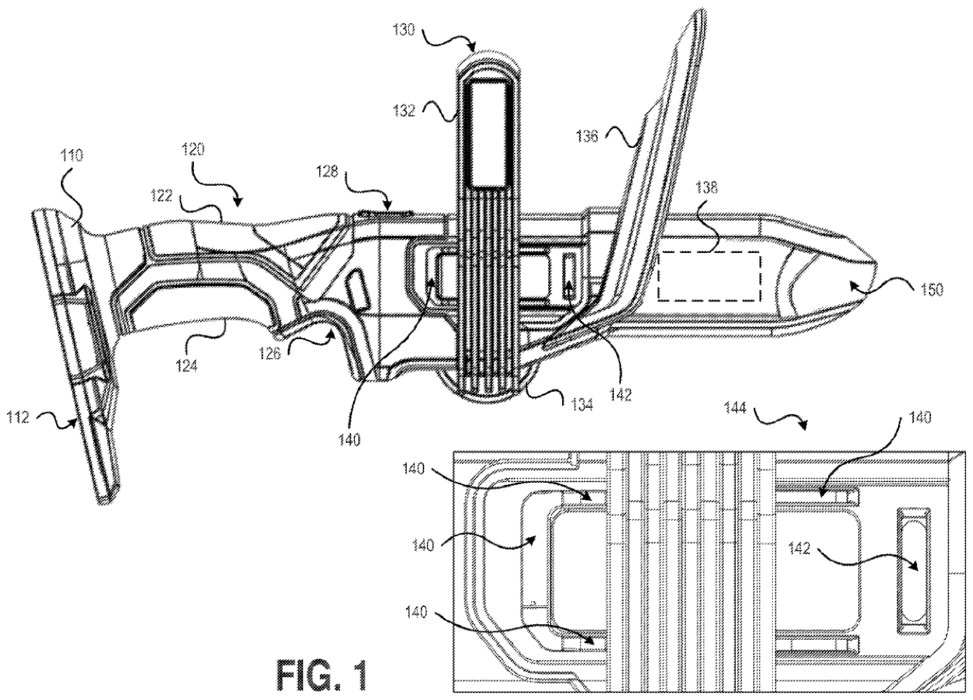

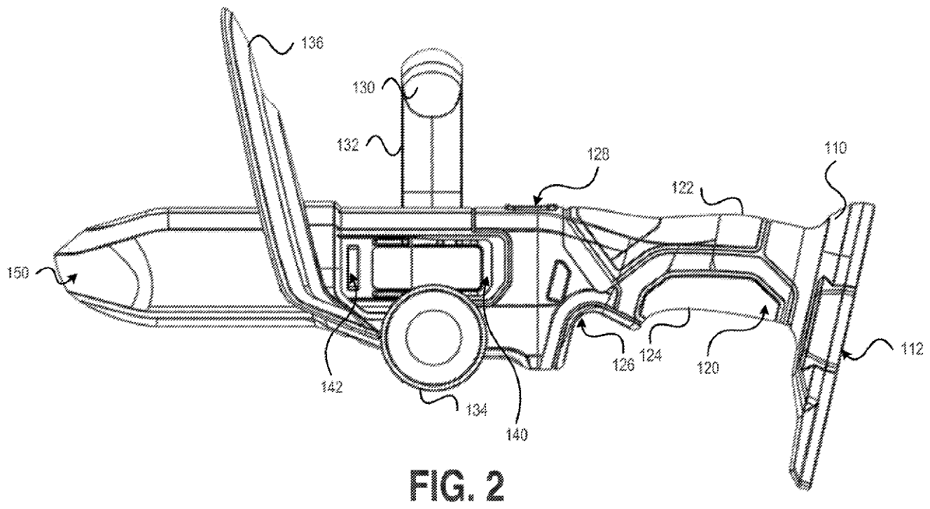

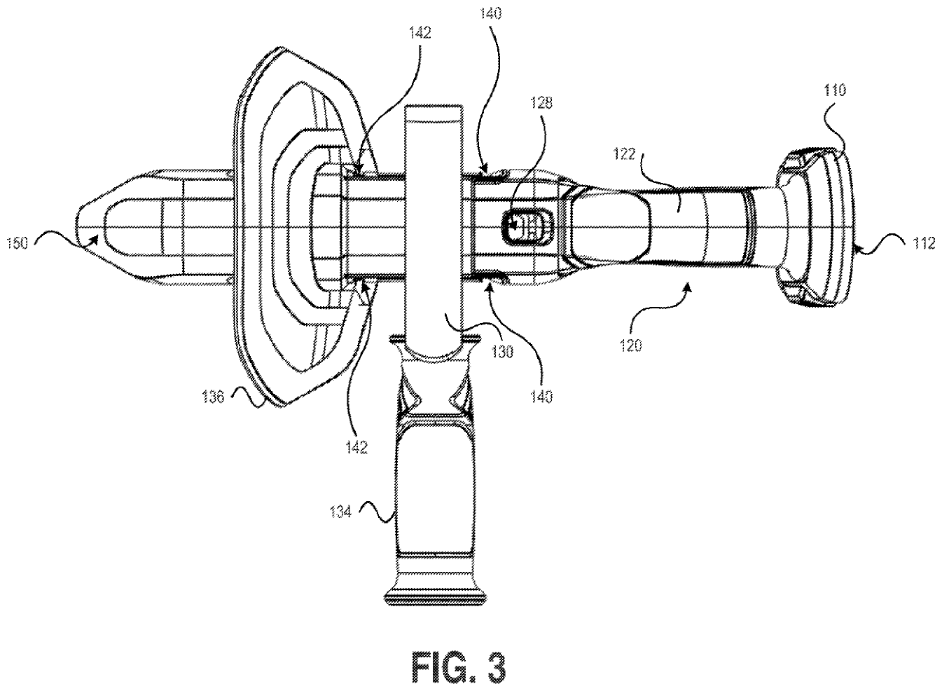

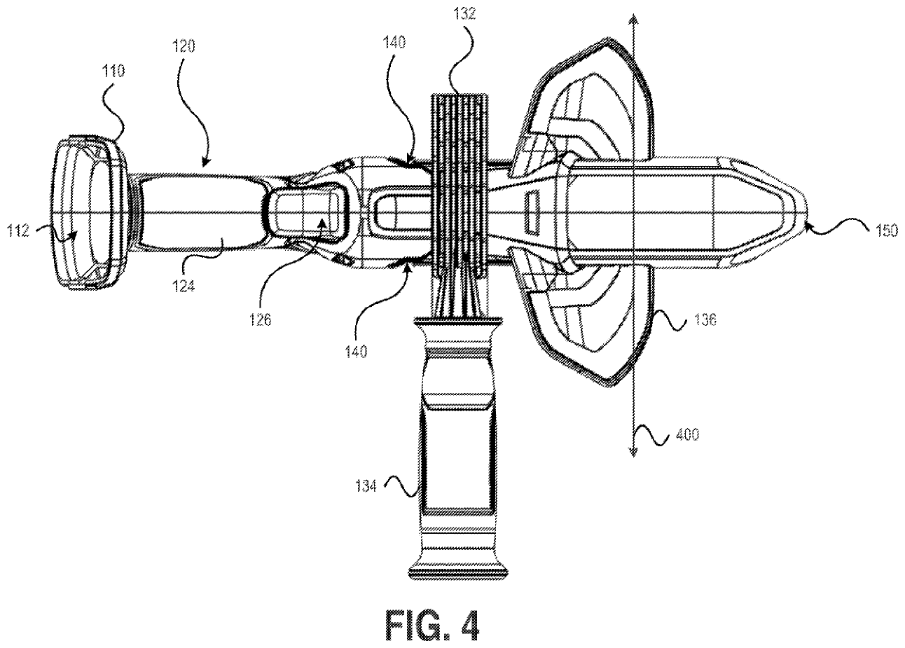

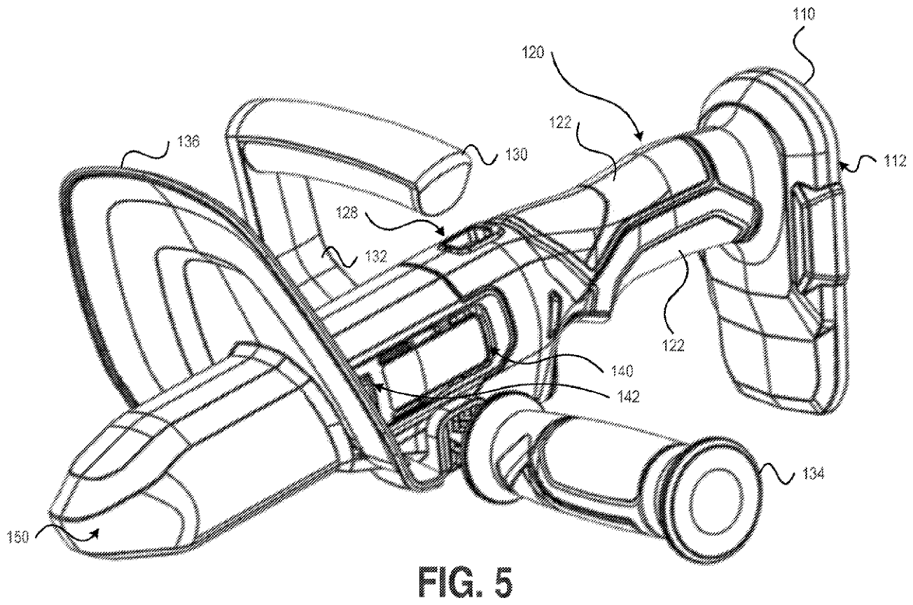

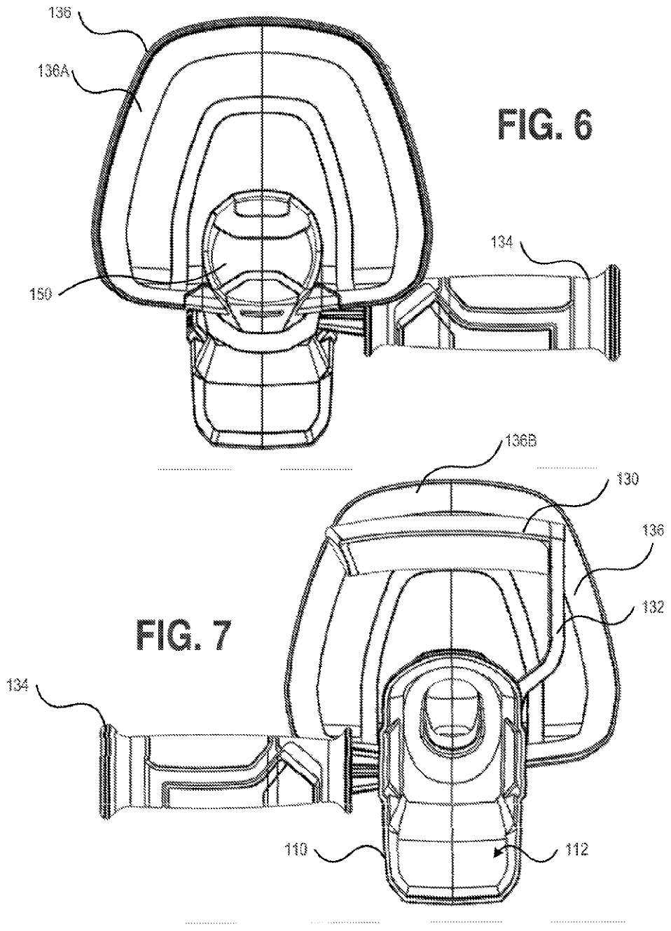

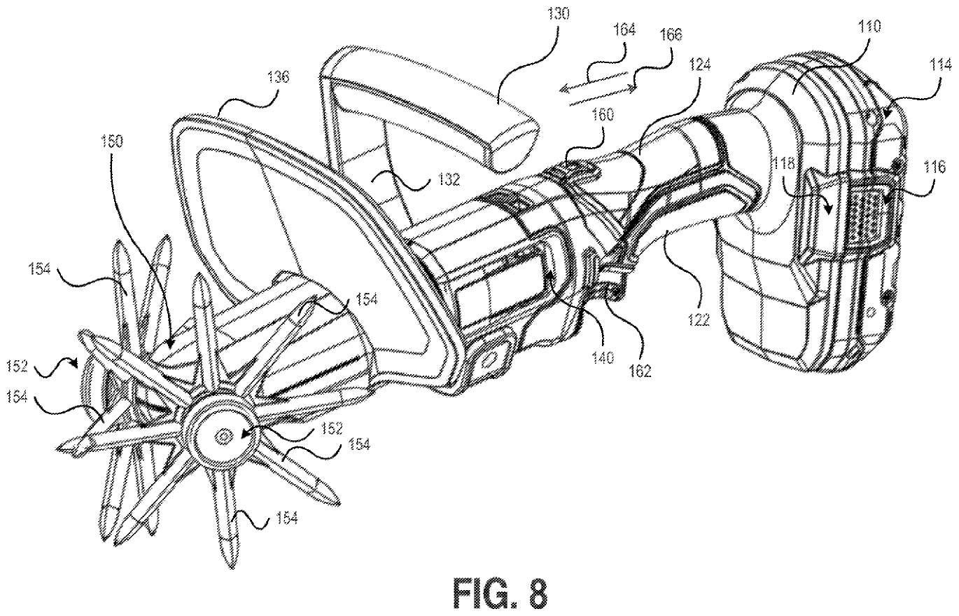

Referring to FIGS. 1-8, various views of a handheld electronic device having a cooling system in accordance with aspects of the present disclosure are shown. In particular, FIGS. 1 and 2 show opposing side views of the handheld electronic device; FIG. 3 shows a top view of the handheld electronic device; FIG. 4 shows a bottom or rear view of the handheld electronic device; FIG. 5 shows a perspective view of the handheld electronic device; FIG. 6 shows a front view of the handheld electronic device; FIG. 7 shows a back or rear view of the handheld electronic device; and FIG. 8 shows another perspective view of the handheld electronic device. As described in more detail below, the cooling system of embodiments may provide improved cooling of handheld electronic devices while also mitigating situations where operation of the device potentially results in damage to or failure of the handheld device.

As shown in FIG. 1, the handheld device may include a first (longitudinal) end 110 and a second (longitudinal) end 150, where the first end 110 is opposite the second end 150 along a longitudinal direction of the handheld device. The first end 110 may define a cavity 112 for receiving a battery 114 (FIG. 8). The battery 114 may be a battery cell, a battery pack, or other type of power storage device. In some aspects, the battery 114 may be rechargeable. A handle region 120 may be disposed proximate the first end 110. The handle region 120 may include a first grip portion 122 and a second grip portion 124. The first grip portion 122 may be contoured to conform to the palm of the user while the second grip portion 124 may be contoured to conform to one or more fingers of the user (e.g., the user may grasp the handheld device by placing his/her palm on the first grip portion 122 and then wrapping his/her hand around the handle region 120). In some aspects, the first grip portion 122 and/or the second grip portion 124 may be covered in a resilient material, such as rubber, to provide additional comfort to the user during operation of the handheld device. The resilient material may compress or deform when gripped by the user to improve comfort and may return to its normal or natural shape. In some aspects, all or a portion of the first grip portion 122 and/or the second grip portion 124 may be covered with dimples or bumps to improve the user's grip and minimize a likelihood that the handheld device slips from the user's grasp during operation of the handheld device.

A housing of the handheld device may include an aperture 126 disposed on a bottom side of the housing of the handheld device, as more readily shown in FIG. 4, and an aperture 128 disposed on a top side of the housing of the handheld device, as more readily shown in FIG. 3. As described in more detail below, the aperture 126 may be configured to receive an activation means that may be used to activate operation of the handheld device. For example, the activation means may be a button or trigger that may be depressed to enable deliver of power to a motor of the handheld device. The aperture 128 may be configured to receive a control means for controlling one or more operational parameters of the handheld device. For example, the control means may be a knob or a wheel that may be rotated to control a speed of the motor, which may in turn control a speed of rotation of one or more tine discs, as described in more detail below. It is noted that the activation means is described as including a button or trigger and the control means is described as including a knob or wheel for purposes of illustration, rather than by way of limitation and that handheld devices according to the concepts disclosed herein may utilize other types of mechanisms to control operation of a handheld device.

To aid the user in controlling the handheld device, a handle 130 may be provided. The handle 130 may be a top handle disposed above the housing of the handheld device. As shown in FIGS. 1, 2, 5, 7, and 8, an arm or extension 132 may be provided to hold the handle 130 above the handheld device, such that the handle 130 is suspended above and extends over the top of the handheld device. In an aspect, the handle 130 and the extension 132 may be formed using a single piece construction technique whereby the handle 130 and the extension 132 are formed as a single unit or piece. In additional or alternative aspects, the handle 130 and the extension 132 may be formed as separate pieces that may be coupled together (e.g., using screws, pins, rods, a snap fit, and the like). In some aspects, a side handle 134 (FIGS. 2-7) may also be provided in addition to or as alternative of the handle 130. The handle 130 (with the extension 132) and the side handle 134 may be removably attached to the housing of the handheld device. For example, the one or more screws or bolts may be utilized to secure the handle 130 and/or the side handle 134 to the housing of the handheld device.

A guard 136 may be disposed proximate the second end 150 of the handheld device. The guard 136 may be configured to prevent soil, liquids, or other materials from being flung onto a user operating the handheld device. It is noted that in some existing handheld tools an air inlet may be disposed between the guard 136 and the second end 150, such as in the vicinity of the box or region 138. While such air inlets may enable cooling air to enter the housing and provide some cooling to internal components (e.g., a motor) of the handheld device, especially cooling of internal components of the handheld device positioned at least partially proximate to the region 138 (e.g., at least partially between the guard the guard 136 and the second end 150), providing air inlets on the front-side 136A of the guard 136 (e.g., between the guard 136 and the second end 150) may allow soil and liquids to enter the housing of the handheld device during use of the handheld device. When this occurs internal components of the handheld device may become damaged. For example, soil, rocks, or other debris entering the housing may become stuck in the motor and liquids entering the housing may cause rust to form on electrical terminals, electrical circuitry, or other metal components of the handheld device (e.g., gears, a drive shaft, and the like) While an immediate failure of the handheld devices may not result from every such occurrence, over time these occurrences may degrade the perform of the handheld device and will eventually lead to a failure of the handheld device.

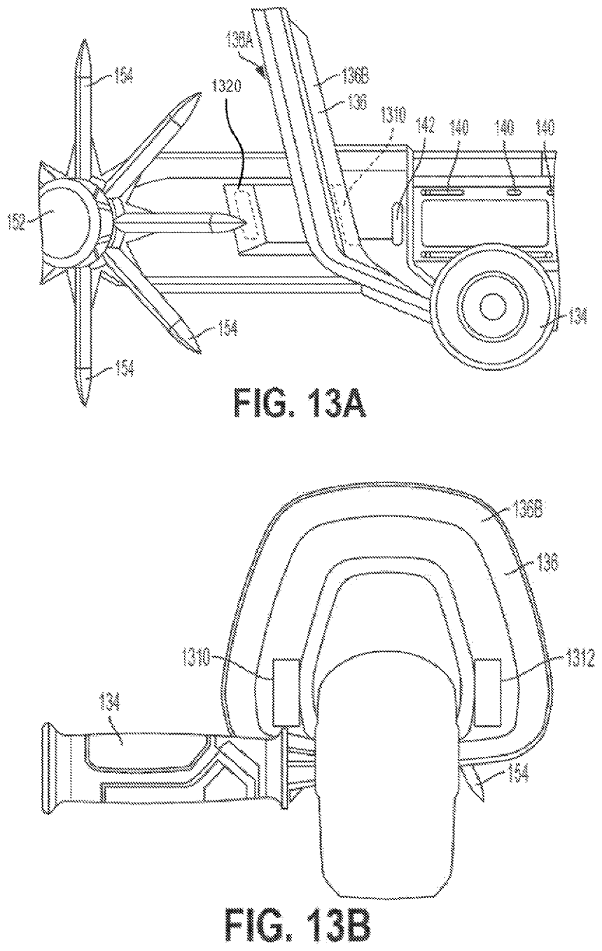

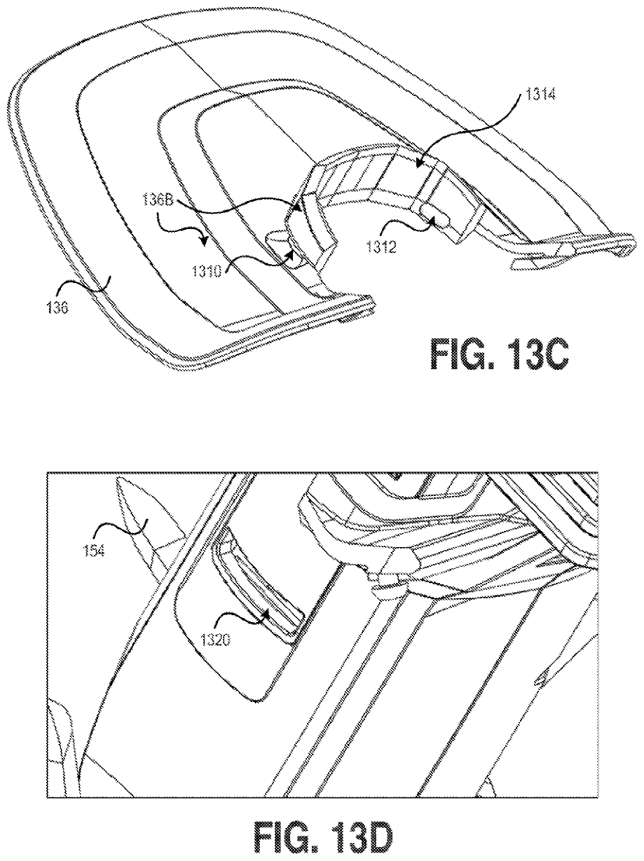

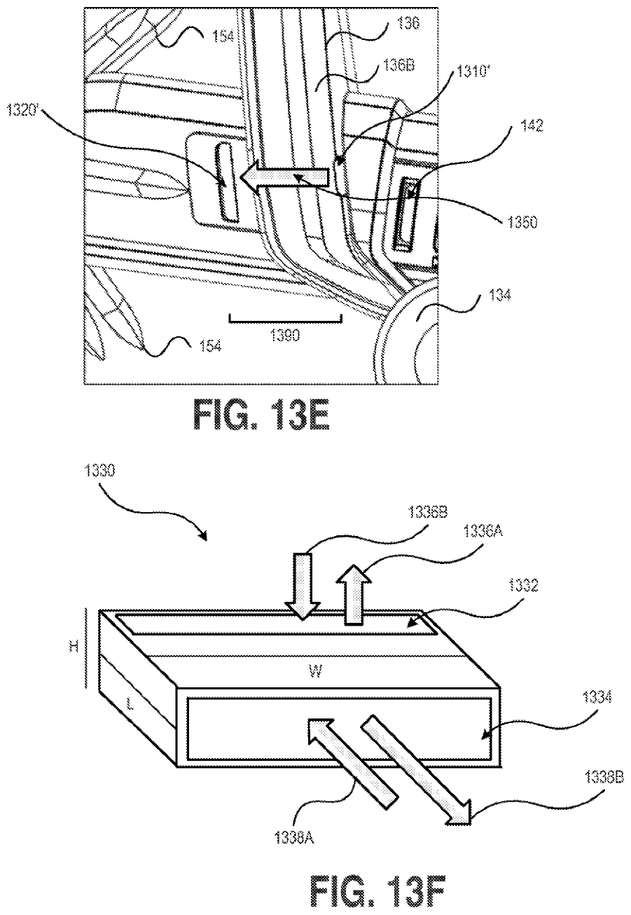

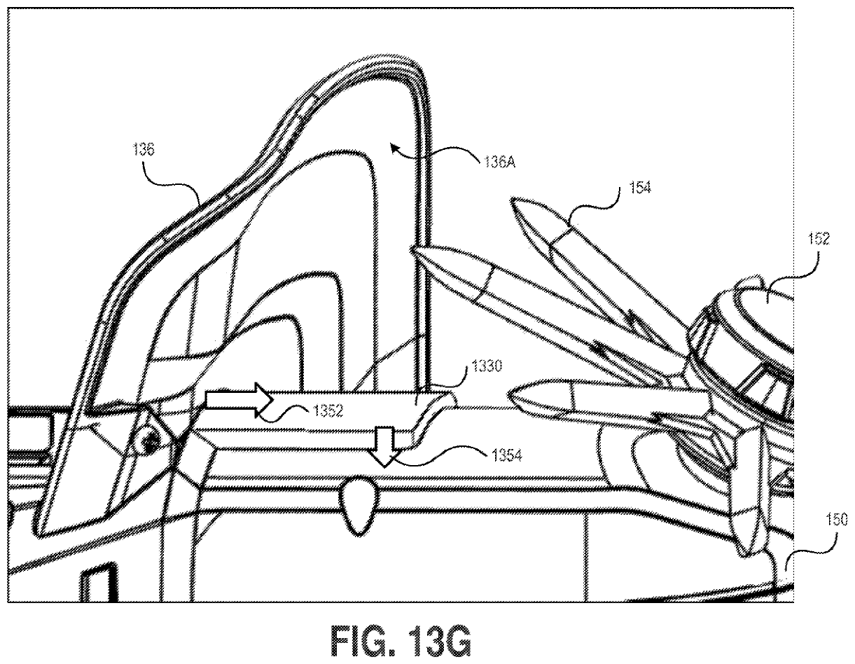

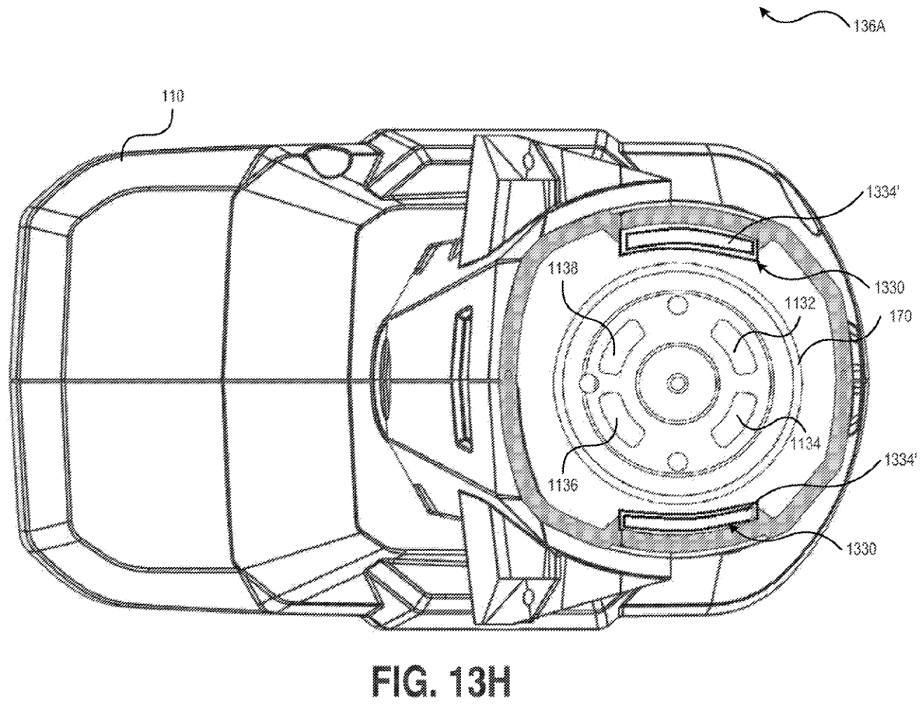

To mitigate damage to, and potential failure of the handheld device, handheld devices according to the present disclosure may not include air inlets that are exposed between the guard 136 and the second end 150 of the handheld device. Instead, the housing of the handheld device may include a plurality of apertures that may be utilized for cooling of components of the handheld device and that are disposed between a backside 136B of the guard 136 and the first end 110. In particular, the plurality of apertures may include air inlets 140 and air outlets 142. It is noted that the plurality of apertures may include a plurality of air inlets, as more readily shown in insert 144 of FIG. 1. It is noted that the plurality of apertures may also include apertures disposed on an opposite side of the handheld device, as shown in FIG. 2. It is also noted that air inlets illustrated in FIGS. 1 and 2 are shown for purposes of illustration, rather than by way of limitation and the other configurations and arrangements of air inlets positioned between the guard 136 and the first end 110 may be provided in accordance with the concepts disclosed herein Additional or alternative exemplary air inlet arrangements are shown in FIGS. 13A-13H***, described in more detail below Including multiple air inlets and air outlets may enable a higher volume of cooling air to be drawn into the housing where the cooling air may be circulated to cool components of the handheld device, such as a motor, a PCB, or other components. As the cooling air circulates it may become heated prior to exiting the handheld device via the air outlets 142. In this manner the circulation of the cooling air may function as a heat exchanger to provide effective cooling of the components of the handheld device.

As shown in FIG. 8, the handheld device may be a handheld electric cultivator and may include at least one tine disk 152 disposed between the second end 150 of the housing and the guard 136. A plurality of tines 154 may extend radially from each tine disk 152. The tines 154 may be formed from a durable material (e.g., steel, etc.) capable of digging into and loosening the soil or material without breaking or deforming. It is noted that the at least one tine disk 152 and the plurality of tines 154 have been provided for purposes of illustration, rather than by way of limitation and that handheld device in accordance with the present disclosure may include other types of working tools, such as an auger bit, a disc brush, a circular blade, and the like. During operation of the handheld device, the tine disk(s) 152 may be driven (e.g, rotated) by a motor in response to depression or activation of an activation means, shown in FIG. 8 as a trigger 162, thereby causing the tines 154 to dig into and loosen soil or other material. As described briefly above, the speed at which the tine disk(s) 152 is driven may be controlled by a control means, shown in FIG. 8 as a wheel 160. Rotation of the control means in a first direction 164 may increase the speed of rotation of the at least one tine disk 152 and rotation of the control means in a second direction 166 may decrease the speed of rotation of the at least one tine disk 152. It is noted that the trigger 162 and the wheel 160 have been provided for purposes of illustration, rather than by way of limitation and that other techniques or devices may be utilized to control activation of the handheld device and/or control operational parameters of the handheld device. For example, rather than wheel 160, the control means may be provided via a slider or other technique. Similarly, the functionality of the trigger 162 for activation of the handheld device may be provided via a switch, a button, and the like. Accordingly, the control means and activation means should not be limited to the specific exemplary hardware or components illustrated in FIG. 8.

As illustrated in FIG. 8, the battery 114 may be secured within the cavity 112 of the first end 110 of the handheld device via a latching or fastening means. The fastening means may include a battery component 116 and a corresponding housing component 118 disposed on a peripheral edge of the first end 110. When the battery 114 is inserted into the cavity 112 the battery component 116 and the housing component 118 may be aligned such that the battery component 116 mates with or becomes secured to the housing component 118. It is noted that the mating of the battery component 116 with the housing component 118 may be accomplished via a snap fit, a compression fit, a latch, or other mechanism capable of securing the battery 114 to the handheld device.

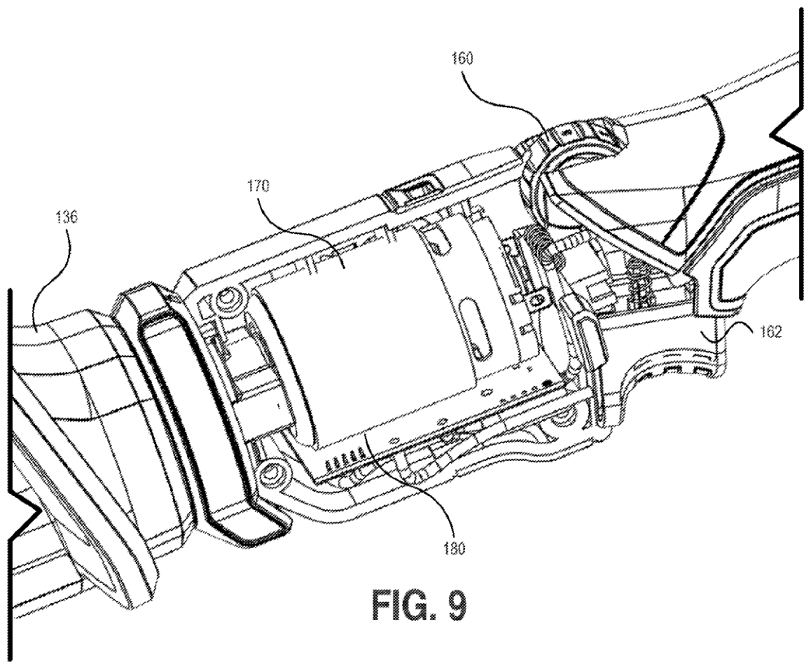

Referring to FIG. 9, a partial view of the handheld device is shown. As shown in FIG. 9, a motor 170 may be disposed within the housing of the handheld device. In some aspects, the motor 170 may be positioned approximately in the middle of the handheld device (e.g., in the longitudinal direction). For example, the motor 170 may be positioned between the activation means (e.g., the trigger 162) and the guard 136. Positioning the motor 170 approximately in the middle of the handheld device may improve the balance of the handheld device and improve the comfort and/or stability during operation. In still other aspects, the motor 170 may be positioned closer to the second end 150 (i.e. forward of center in the longitudinal direction). Positioning the motor 170 in this manner may naturally tilt the handheld device downward, thereby allowing the natural posture of the handheld device (when held by a user) to place the at least one tine disk 152 and the tines 154 closer to the soil or material to be cultivated or tilled. It is noted that the exemplary locations of the motor 170 described above have been provided for purposes of illustration, rather than by way of limitation and that other arrangements and positioning of the motor 170 may be utilized in accordance with the concepts disclosed herein.

In addition to the motor 170, a PCB 180 may also be positioned within the housing of the handheld device. The PCB 180 may include circuitry and other components that may control operation of the handheld device. For example, the PCB 180 may be in communication (e.g., via one or more wires, etc) with the control means (e.g, the wheel 160) and the activation means (e.g., the trigger 162). The PCB 180 may detect depression of the activation means and provide a control signal and/or a power signal to the motor 170. To illustrate, upon detecting activation of the activation means, the PCB 180 may determine a speed of the motor 170 based on the control means and provide a control signal to the motor 170 to configure the motor 170 to operate in accordance with the speed configured by the control means. Additionally, the PCB 180 may activate a switch or other mechanism to provide operational power to the motor 170, thereby enabling operation of the motor 170 based on the control signal. It is noted that the description above has been provided for purposes of illustration, rather than by way of limitation and that other techniques may be utilized to control operation of the motor 170, including implementations that do not include the PCB 180.

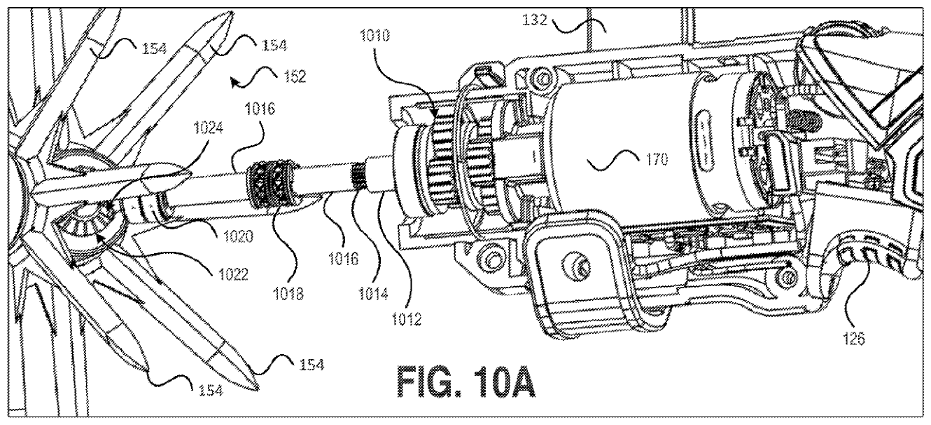

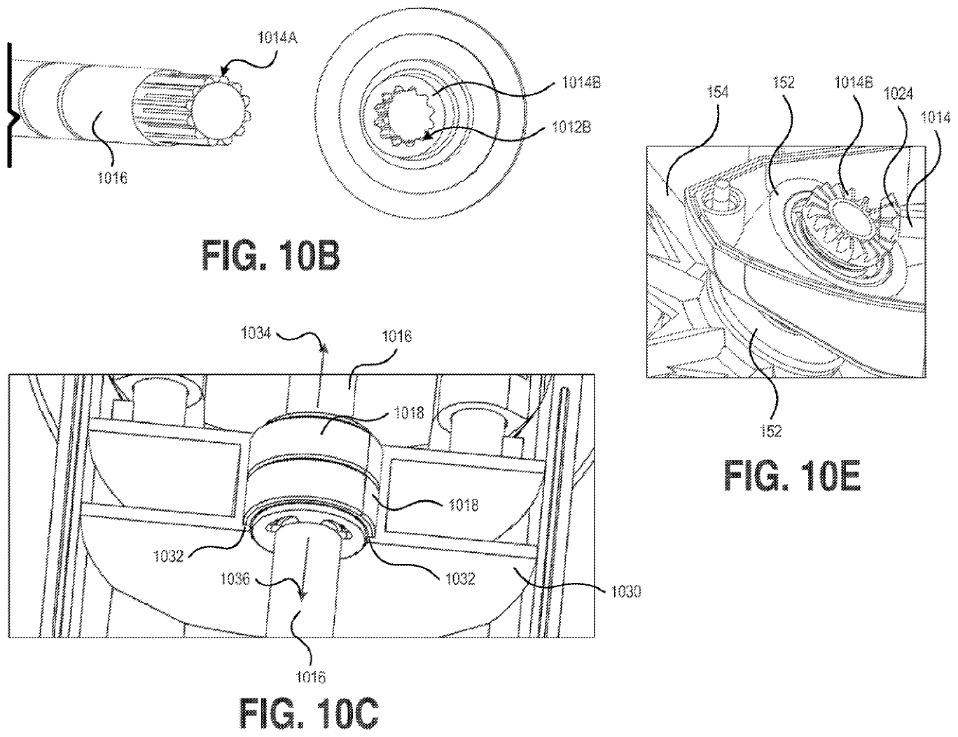

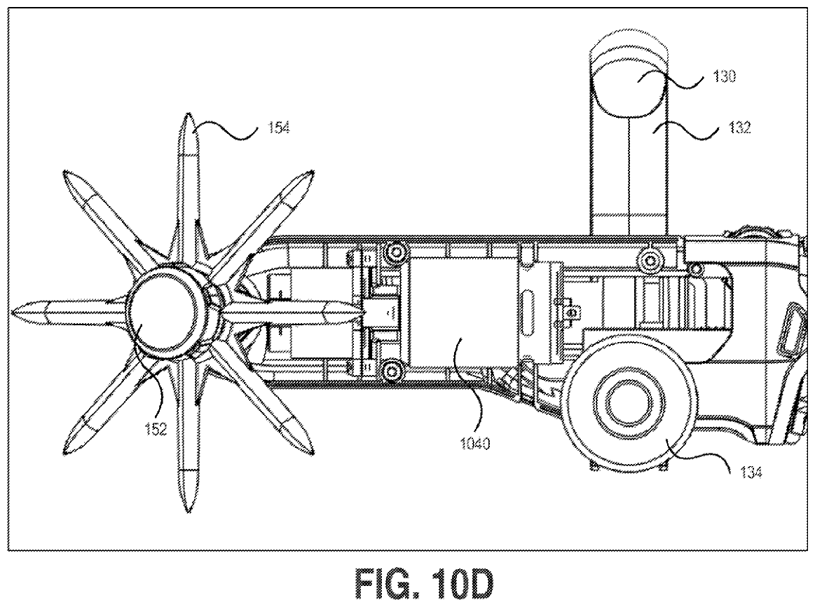

Referring to FIG. 10A, a diagram illustrating an exemplary drivetrain for a handheld device is shown. As described above, a handheld device according to the present disclosure may include a motor 170 that may be activated via an activation means (e.g., the trigger 162) to drive at least one tine disk 152. When driven, tines 154 extending radially from the at least one tine disk 152 may be rotated and rotation of the tines may enable the operator to loosen soil or another material as the tines 154 move through the soil or material. When the motor 170 is activated, a drive shaft of the motor 170 may drive a set of gears 1010. The gears 1010 may be configured to transfer the rotational force of the driveshaft to one or more driveshaft extensions 1012, 1016. In some aspects, one or more of the driveshaft extensions may be connected via a connection means. For example, the driveshaft extensions 1012, 1016 may be connected via threaded fit a friction fit, a snap fit, pins, a torx-like interface, or another type of connection mechanism. For example, in FIG. 10B the driveshaft extension 1016 is shown to have a male torx-like interface 1014A and driveshaft extension 1012 is shown to have a female torx-like interface 1014B.

Referring back to FIG. 10A, one or more stabilizers may be provided to stabilize the drivetrain. In the exemplary embodiment shown in FIG. 10A, the stabilizers may be bearings configured to support the drivetrain while maintaining the ability of the drivetrain to freely rotate so as to drive the tine disk(s) 152. For example, bearings 1018 (shown without a protective cover) and bearings 1020 (shown with a protective cover) may be provided. In some aspects, the stabilizers may include additional structures or components disposed within the housing of the handheld device. For example, FIG. 10C shows a partial view of the handheld device that includes a support bracket 1030 that is configured to support or cradle the bearings 1018 (shown with the protective cover). The support bracket may include tabs or dingers 1032 configured to wrap around the bearings 1018 and prevent the bearings 1018 from sliding in the directions shown by arrows 1034, 1036. It is noted that FIG. 10C only shows half of the support bracket 1030 and that the other half of the support bracket may be identical to or substantially similar to the portion of the support bracket 1030 shown in FIG. 10C. Additionally, it is noted that a similar support bracket may be provided for bearings 1020.

To facilitate transfer of the rotational force of the driveshaft extension 1016 to the tine disk(s) 152, one or more transfer gears may be utilized. For example, FIGS. 10A and 10E illustrate that a transfer gear 1022 may be disposed on an interior surface of the tine disk(s) 152 and a transfer gear 1024 may be disposed at the end of the driveshaft extension 1016. As rotational force is delivered to the driveshaft extension 1016 by the drive shaft of the motor 170 (or the motor 1040) and the driveshaft extension 1012, the driveshaft extension 1016 may rotate and the transfer gear 1024 may also rotate. As the transfer gear 1024 rotates, a rotational force may be imparted to the transfer gear 1022, which may cause rotation of the tine disk(s) 152 and the tines 154. It is noted that the speed of rotation of the tine disk 152, the tines 154, the driveshaft extensions, and the transfer gears may be controlled using the control means (e.g., the wheel 160), as described above.

It is noted that the exemplary arrangement of the motor 170 and the drivetrain shown in FIG. 10A is provided for purposes of illustration, rather than by way of limitation and that handheld devices (e g . . . handheld cultivators) in accordance with the present disclosure may utilize other drivetrain lengths and configurations depending on the position of the motor For example, FIG. 10D illustrates a partial view of a handheld device having a motor 1040 that is positioned forward (i.e., towards the second end 150) of the handheld device. In particular, the motor 1040 is positioned between the guard 136 and the second end 150. As described above, a forward positioned motor may provide a natural tilt of the handheld device when held by the user such that the tine disk(s) 152 and the tines 154 are oriented towards the soil or material to be cultivated, which may provide more comfort during operation of the handheld device. As a result of the different positioning of the motor 1040 shown in FIG. 10D, as compared to the position of the motor in FIG. 10A, the drivetrain may be shorter. It is noted that while the length of the drivetrain may change depending on the position of the motor, the drivetrain may utilize components similar to those described and illustrated with reference to FIGS. 10A-10C, such as the driveshaft extensions, stabilizers, bearings, gears, and the like.

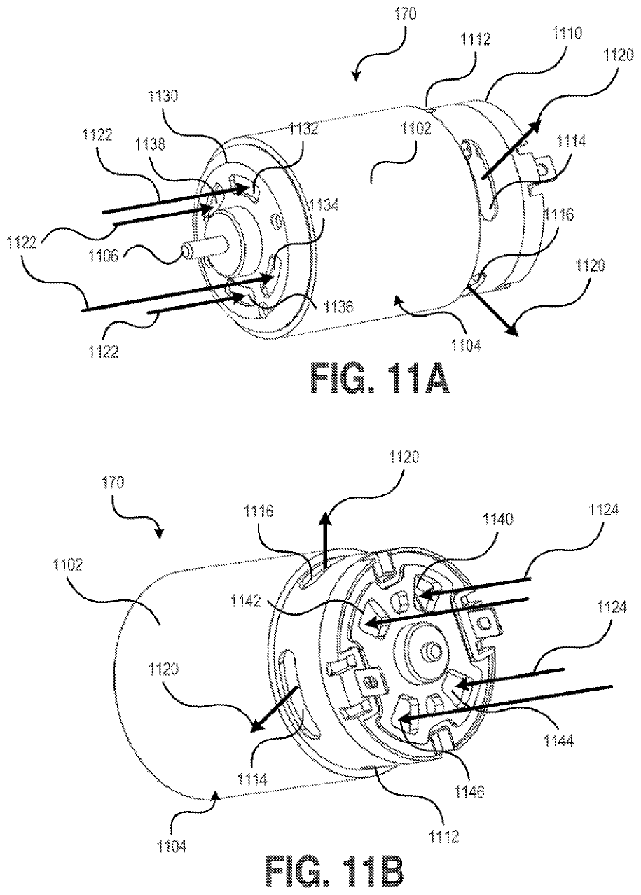

Referring to FIG. 11A, a diagram illustrating an exemplary motor for a handheld device suitable for a cooling system in accordance with aspects of the present disclosure is shown. As shown in FIGS. 11A and 11B, the motor 170 may be a canister-type motor in which a rotor and stator of the motor 170 may be disposed within a casing or canister 1102. The casing 1102 of the motor 170 may be of a generally cylindrical shape having a first end 1110 and a second end 1130. The ends 1110, 1130 may be connected via a sidewall or side surface 1104, which may wrap around a circumference casing 1102. A rotatable drive member 1106 may extend beyond an exterior surface of the casing 1102. The rotatable drive member 1106 may be coupled to or serve as a drive shaft for driving the components of the drivetrain, as described above with reference to FIGS. 10A-10E.

As the motor 170 is operated heat may be generated. To cool the motor 170, at least one air intake aperture and at least one air exhaust aperture may be provided. To illustrate, the exemplary embodiment of FIGS. 11A and 11B shows the casing 1102 defining air exhaust apertures 1112, 1114, 1116 proximate first end 1110 and air intake apertures 1132, 1134, 1136, 1138 disposed proximate the second end 1130. As shown by arrows 1122, cooling air drawn into the housing of the handheld device (e.g., by a centrifugal fan in the motor) may enter the casing 1102 via the air intake apertures 1132, 1134, 1136, 1138 and exit the casing 1102 via the air exhaust apertures 1112, 1114, 1116, as shown by arrows 1120. Additionally or alternatively, the casing 1102 may define air intake apertures 1140, 1142, 1144, 1146 disposed proximate the first end 1110, as shown in FIG. 11B. Cooling air drawn into the housing of the handheld device (e.g., by a centrifugal fan in the motor) may enter the casing 1102 via the air intake apertures 1140, 1142, 1144, 1146, as shown by arrows 1124, and may exit the casing 1102 via the air exhaust apertures 1112, 1114, 1116, as shown by arrows 1120. As the cooling air is drawn into the housing and the motor 170 it may pass over an exterior surface of the motor 170, thereby drawing heat from the casing 1102 and cooling the motor 170. Additionally, the cooling air may draw heat from components held within the casing 1102, such as the stator and rotor, as the cooling air enters into the casing 1102 via the air intake apertures. It is noted that the cooling air may also draw heat from components held outside the casing 1102, such as the PCB, as the cooling air enters or travels within the housing. As the cooling air draws heat from the motor 170 (or other components of the handheld device) the cooling air may be heated. The heated air may then exit the motor 170 via the air exhaust apertures. The motor 170 may be mounted within the housing of the handheld device such that the air exhaust apertures are aligned with the air outlets 142, thereby allowing the heated air to exit the housing of the handheld device and preventing the heated air from be recirculated through the motor 170.

In an aspect, the ability to draw cooling air into the air intake apertures may be enhanced by providing one or more protected air channels internal to, or external to the housing of the handheld device. According to the present disclosure, a protected air channel may be an air channel designed to mitigate a likelihood that debris or liquids enter the housing and potentially cause damage to components of the handheld device disposed therein. In some aspects, the protected air channels draw cooling air from air inlets disposed at a middle or rear region of the handheld device and then direct the cooling air towards portions of the interior space of the housing that are disposed in the front region of the handheld device. For example, a protected air channel of embodiments may draw cooling air from an air inlet disposed distal to the working tool (i.e., between the guard 136 and the first end 110), and then direct the cooling air to components disposed within the housing at least partially proximate to the working tool (i.e., the cooling air is delivered to a location within the housing that is between the guard 136 and the working tool).

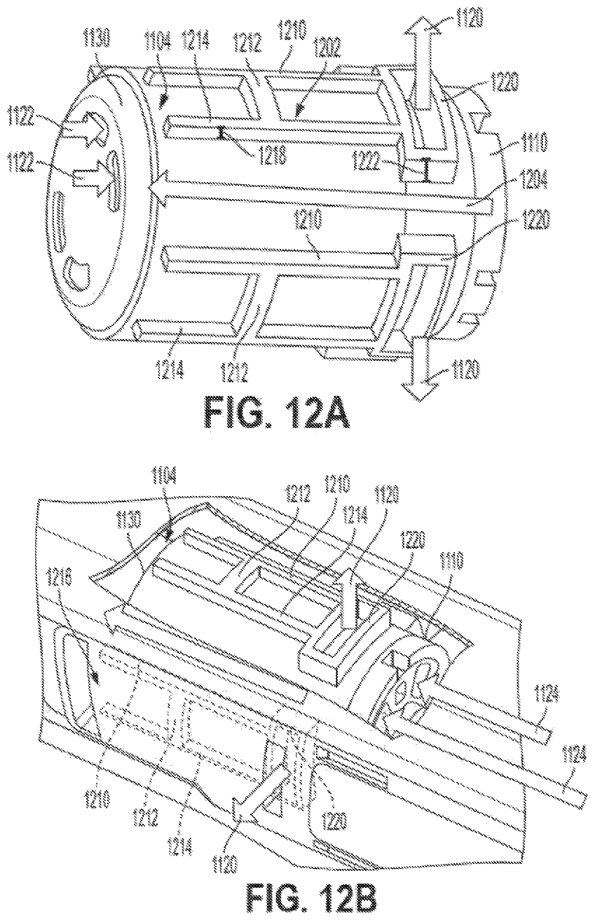

Referring to FIGS. 12A and 12B, various partial views of a handheld device having a cooling system in accordance with aspects of the present disclosure are shown. In FIG. 12A, a motor (e.g., the motor 170 of FIGS. 9 and 10A or the motor 1040 of FIG. 10D) is shown. To secure the motor within the handheld device, a motor mount 1202 may be disposed within the housing. In some aspects, the motor mount 1202 may be attached (e.g., using an adhesive, over molding, or other techniques) to the housing of the handheld device. In additional or alternative aspects, the motor mount 1202 may be attached (e.g. using an adhesive, over molding, or other techniques) to the motor. In some aspects, the motor mount 1202 may be formed as part of the housing.

The motor mount 1202 may include a plurality of ribs 1210, 1214 and one or more exhaust caps 1220. As shown in FIGS. 12A and 12B, each of the ribs 1210, 1214 may extend outward from one of the exhaust caps 1220 in a direction parallel to a longitudinal axis of the motor One or more protected air channel(s) 1204 may be defined between different pairs of ribs 1210, 1214. The protected air channel(s) 1204 may enable cooling air to travel over the exterior surface 1104 of the motor (or the motor casing), as more readily shown in FIG. 12B, which illustrates a view of the motor and motor mount within a housing of a handheld device in accordance with the concepts disclosed herein. In some aspects, the cooling air may travel over the exterior surface 1104 in a first direction (e.g., from the first end 1110 towards the second end 1130), as shown by arrow 1204. In additional or alternative aspects, the cooling air may travel over the exterior surface 1104 in a second direction (e.g., from the second end 1130 towards the first end 1110). In an aspect, the direction of travel that the cooling air takes within the air channel 1204 may be dependent on a location and/or orientation of the fan utilized to draw the cooling air into the housing of the handheld device. To illustrate, the fan could be a centrifugal fan arranged inside the motor and immediately adjacent the air exhaust outlets of the motor. Alternatively, the fan may be a centrifugal fan or axial fan disposed within the housing between the first end 1110 and the air inlets 140 of the housing. In such an arrangement the fan may draw cooling air into the housing via the air inlets 140 and then push the cooling air towards the motor.

A portion of the cooling air may enter the motor casing via the air intake apertures 1140, 1142, 1144, 1146, as shown by arrows 1124. Another portion of the cooling air may pass over an exterior surface of the motor via the air channel(s) defined between different pairs of the ribs 1210, 1214, such as via the protected air channel 1204 The cooling air passing through the protected air channel 1204 may subsequently enter the air intake apertures 1132, 1134, 1136, 1138, as shown by arrows 1122. As the cooling air passes over the exterior surface 1104 of the motor (or motor casing) it may draw heat from the motor. Additional heat may be drawn from the motor as the cooling air enters the motor (or motor casing) via the air intake apertures and then the heated air may then exit the motor via air exhaust outlets of the motor (e.g., the air exhaust outlets 1112, 1114, 1116 of FIGS. 11A, 11B). It is noted that while the ribs 1210, 1214 shown in FIGS. 12A and 12B are linear, in some aspects ribs utilized to provide air channels in accordance with the present disclosure may be provided in other form factors. For example, the ribs may be curved or have bends in them. The ability to provide bent or curved air channels may help the protected air channels to direct the cooling air over hot spots (e.g., portions of the motor or other components that get hotter than other areas) and/or output the cooling air closer to the air intake apertures of the motor or other components. In an aspect, one or more support ribs 1212 may be provided. Each support rib 1212 may be positioned between a rib 1210 and a rib 1214 (e.g., one support rib for each exhaust cap/rib pair). The support rib 1212 may provide structural stability for the support ribs and provide improved or more secure attachment of the ribs 1210, 1214 to the housing, the motor, or both. It is noted that the cooling air drawn into the air intake apertures 1140, 1142, 1144, 1146 may not require a protected air channel since those air intake apertures are located proximate the air inlet from which the cooling air is drawn (i.e., the air intake apertures 1140, 1142, 1144, 1146 are between the guard 136 and the first end 110 and proximate the air inlets 140).

The one or more exhaust caps 1220 may be configured to surround the air exhaust apertures of the motor (e.g, the air exhaust outlets 1112, 1114, 1116 of FIGS. 11A, 11B) and align with the air outlets 142 of the housing of the handheld device. In such an arrangement, the exhaust cap(s) 1220 may act as a seal to force the air that is heated as it passes over and through the motor through the air exhaust aperture and the air outlets (i.e., outside the handheld device), which may prevent the heated air from cycling back through the motor and diminishing the cooling effect. In some aspects, a gasket or seal may be disposed between the exhaust caps 1220 and the exterior surface of the motor casing and/or the housing, which may prevent the heated air from leaking back into the housing of the handheld device.

In an aspect, the plurality of ribs 1210, 1214 may be configured to engage an exterior of the motor. A height of the ribs may be such that the ribs extend vertically or radially outward from the surface 1104 of the motor (or casing) to an interior surface of the housing, thereby providing a seal that isolates the protected air channel(s) 1204. Such isolation of the air channels may direct more of the cooling air to the opposite end of the motor (e.g., from the first end 1110 towards the second end 1130 or from the second end 1130 towards the first end 1110 depending on the particular air flow configuration and the location/orientation of the centrifugal fan). In an aspect, a pair of ribs may be provided for each exhaust cap 1220 and the air channel(s) 1204 may be defined by ribs from different pairs of ribs corresponding to different exhaust caps 1220. For example, in FIGS. 12A and 12B the protected air channel 1204 is defined by a rib 1210 and a rib 1214.

Due to the heat generated by the motor, in some aspects, the plurality of ribs and the exhaust caps may be formed from a heat resistant material (e.g., a heat resistant rubber, plastic, or other material). In some aspects, the protected air channel(s) 1204 may be configured or arranged such that the output of the protected air channel(s) is proximate a corresponding one of the air intake apertures. For example, a motor mount suitable for use with the motor of FIGS. 11A and 11B may define 4 air channels, each air channel having an outlet configured to output cooling air proximate one of the air intake apertures 1132, 1134, 1136, 1138 or the air intake apertures 1140, 1142, 1144, 1146 depending on the particular direction of air flow within the protected air channel(s). Similarly, the motor mount may define or include an exhaust cap for each air exhaust outlet of the motor. To illustrate, a motor mount suitable for use with the motor of FIGS. 11A and 11B may define 4 exhaust caps, one for each of the air exhaust outlets 1112, 1114, 1116, and one for a fourth air exhaust outlet (not shown in FIGS. L11A and 11B) It is noted that while the drawings illustrate the ribs 1210, 1214 as being open at the end, in some aspects a support rib may also be provided at the end of the ribs 1210, 1214 proximate the end 1130 of the motor.

Providing the motor mount 1202 shown in FIGS. 12A and 12B may be particular suited to cooling systems for handheld devices where the motor is positioned predominantly on one side of the air inlets of the housing. For example, in the exemplary embodiments illustrated in FIGS. 1-5 and 8, the motor may be positioned forward (i.e., towards the second end 150) of the air inlets 140. In such an embodiment, the protected air channels provided by the motor mount 1202 may improve air flow towards the distal air intake apertures of the motor (or motor casing), resulting in improved cooling of the motor via more even distribution of the cooling air to the entire motor and resulting in more heat being drawn from the motor by the cooling system. However, in some embodiments of the present disclosure additional air inlets may be provided to increase the flow of cooling air within the handheld device without needing to utilize a motor mount 1202.

For example and referring to FIGS. 13A and 13B, a partial view of a handheld device having a cooling system in accordance with the present disclosure is shown. As briefly described above, having air inlets between the guard 136 and the second end 150 of a handheld cultivator device may allow debris or liquids to enter the housing, which can damage internal components of the handheld cultivator, such as the motor, PCB, or other components. To provide improved or increased air flow within the housing, protected air channels may be provided via inlets of the housing that are supplied with cooling air via vents 1310, 1312 within the guard 136. As shown in FIG. 13C, the vents 1310, 1312 may be exposed or open up to the backside surface of the guard and may open up to an interior surface 1314 of the guard 136 (i.e., a surface configured to attach to or rest upon the housing of the handheld device). In particular, the vents 1310, 1312 may be disposed on a backside surface 136B of the guard (i.e., a surface of the guard 136 facing first end 110) and may be inaccessible from the front-side surface 136A of the guard (i.e., a surface of the guard facing the second end 150). As shown in FIG. 13D, the housing of the handheld device may include air inlets 1320 that may be configured to align with the openings on the interior surface 1314 of the guard 136 to allow cooling air to be drawn through the vents 1310, 1312 and into the air inlets 1320, thereby allowing an additional volume of cooling air to be drawn into the housing of the handheld device for cooling the motor or other components of the handheld device.

In some aspects, the air inlets 1320 may not be aligned with the openings on the interior surface 1314 of the guard 136. For example and referring to FIG. 13E, a vent 1310′ and an air inlet 1320′ may be separated by a distance 1390 longitudinally with respect to the length of the handheld device. Additionally, unlike the vent 1310 of FIG. 13C, which opens up towards the housing of the handheld device, the vent 1310′ may open up to the front surface 136A of the guard 136, as indicated by arrow 1350. An air intake extension (or vent extension) may be utilized to provide a protected air channel for delivering cooling air from the vent 1310′ to the air inlet 1320′ for cooling one or more components of the handheld device (e.g., the motor, PCB, and the like).

Referring to FIG. 13F, a block diagram of an exemplary air intake extension in accordance with aspects of the present disclosure is shown as air intake extension 1330. The air intake extension 1330 may have a length (L), a width (W), and a height (H), and may include a plurality of apertures, such as apertures 1332, 1334. Depending on the particular orientation of the vents and air inlets, the aperture 1332 may operate to receive cooling air from a vent (e.g., the vent 1310′) disposed on the guard and the aperture 1334 may introduce the cooling air into the housing of the handheld device, as shown by arrows 1336B and 1338B. Alternatively, the aperture 1334 may operate to receive cooling air from a vent (e.g., the vent 1310′) of the guard and the inlet 1332 may introduce the cooling air into the housing of the handheld device, as shown by arrows 1336A and 1338A. For example, in the vent/inlet configuration of FIG. 13E, the aperture 1334 may be disposed between the front-side of the guard 136 and second end 150 of the handheld device. In such an arrangement, the cooling air drawn into the vent 1310′ may enter the air intake extension 1330 via the aperture 1334 and may be delivered to air inlet 1320′ via the aperture 1332 (i.e., via the air flow path of arrows 1338A and 1336A). It is noted that an air intake extension may also be used with vents that do not open up to the front-side of the guard 136. For example, in an embodiment utilizing the vent 1310 of FIG. BC, which opens towards the housing instead of the front-side of the guard (as shown at 1312 in FIG. BC), the aperture 1332 may be positioned to receive cooling air drawn through vent 1310 and then provide a protected air channel that may deliver the cooling air to a desired location within the housing of the handheld device.

Referring to FIG. 13G, a partial view of a handheld device having an air intake extension in accordance with aspects of the present disclosure is shown. In FIG. 13G, air flow is shown by arrows 1352 and 1354. As can be appreciated from the illustration of FIG. 13G, utilizing the air intake extension 1330 enables cooling air to be received via a vent (e.g., the vent 1310′ of FIG. 13E) disposed within the guard 136 and then delivered to a location that is forward of the guard 136 (i.e., towards the second end 150 and the working tool of the handheld device), such as the vent 1320′ of FIG. 13E.

While FIG. 13G illustrates the air intake extension 1330 being disposed on an outer surface of the housing, in some embodiments the air intake extension may be provided on an interior surface of the housing of a handheld device in accordance with the present disclosure. For example and referring to FIG. 13H, a partial view showing a cross-section of a handheld device in accordance with aspects of the present disclosure is shown. It is noted that the cross-section shown in FIG. 13H may represent a cross section taken along the line 400 of FIG. 4 and viewing the handheld device looking from the second end 150 towards the first end 110. As shown in FIG. 13H, air intake extensions 1330′ may be provided on an interior of the housing and aperture 1334′ may be provided to deposit cooling air proximate the motor 170 and more specifically, proximate air intake apertures 1132, 1134, 1136, 1138 of the motor 170.

It is noted that the exemplary air intake extension shown in FIGS. 13F-H has been provided for purposes of illustration, rather than by way of limitation and that air intake extensions of embodiments may be provided in different form factors and arrangements. For example, the exemplary air intake extension 1330 of FIG. 13F is shown as including an aperture 1332 on a top surface (relative to orientation shown in FIG. BF) and aperture 1334 on an end surface (relative to orientation shown in FIG. 13F). However, in some aspects the apertures may be disposed on a same surface of the air intake extension (e.g., aperture 1334 could be on a same surface as aperture 1332), opposing surfaces (e.g., aperture 1334 may be disposed on a surface opposite the surface on which aperture 1332 is disposed), or the apertures may be configured according to other arrangements. Additionally, in some aspects the air intake extensions of embodiments may include more than two apertures, such as one aperture for drawing cooling air from the vent and two or more apertures for delivering the cooling air to desired locations within the housing of the handheld device (e.g., an aperture for delivering a first portion of the cooling air proximate a PCB and another aperture for delivering a second portion of the cooling air proximate an intake aperture of the motor). As shown above, air intake extensions of embodiments may provide protected air channels that may be used to draw cooling air into the housing of a handheld device from behind the guard 136 and direct the flow of the cooling air to locations proximate components of the handheld device that generate heat, which may include delivering cooling air to components located within the housing at positions that are between the guard 136 and the working tool. Moreover, because the protected air channels provided by the air intake extensions of embodiments are not exposed to the front-side 136A of the guard 136, liquids, debris, or other materials may be prevented from entering the housing during operation of the working tool of the handheld device.

In an aspect a seal or gasket (not shown in FIGS. 13A-13D) may be provided between the interior surface 1314 of the guard 136 and the exterior surface of the housing. The seal or gasket may be configured to prevent liquids or other debris and materials from entering the housing. Moreover, since the vents 1310, 1312 are disposed on a backside surface of the guard 136 (relative to the location of the tine disk(s) 152 and the tines 154), any materials (e.g., soil, rocks, etc.) or liquids that are flung into the air may contact the front surface of the guard (e.g., the side of the guard facing the tine disk(s) 152 and the tines 154), but may not enter the vents 1310, 1312. It is noted that while FIGS. 13A-13D illustrate the vents and additional air inlets as being disposed on a side of the guard/housing, other arrangements are possible in accordance with the present disclosure. For example, vents may be disposed on a top side of the guard/housing, the sides, and/or other locations so long as the vents/additional inlets are inaccessible to the front-side of the guard. Moreover, it is to be understood that two vents/additional inlets have been shown for purposes of illustration, rather than by way of limitation and that embodiments of the present disclosure may utilize more than two or less than two vents/additional inlets.

By providing a vent(s) and an inlet(s) as shown in FIGS. 13A-13D, cooling air may be drawn into the housing proximate a first end of the motor (e.g., the end 150) while additional cooling air may be drawn into the housing via the inlets 140, which may be disposed proximate a second end of the motor (e.g., the end 110). In this manner, cooling air may be drawn into both ends of the motor without needing to utilize the motor mount 1202 of FIGS. 12A and 12B. However, in some embodiments motor mounts 1202 may be used in combination with the vents and additional inlets. For example, an air channel provided by a motor mount 1202 may be utilized to provide additional cooling air to a particular side of the motor, which may be advantageous depending on whether the vents 1310, 1312 and inlets 1320 or the inlets 140 draw a higher volume of cooling air into the housing or if the motor generates more heat at a particular end or location. An additional benefit may be the ability to draw cooling air into the housing proximate the motor via the vent/inlet pair(s) when the motor is mounted more forward in the housing (i.e., towards the second end 150) as compared to if only the inlets 140 were used. It is noted that a person or ordinary skill may also recognize other advantages provided by using motor mounts in combination with the vent/inlet pairs of FIGS. 13A-13D, and that the non-limiting examples described herein are provided for purposes of illustration, rather than by way of limitation.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, the scope of the present application is not intended to be limited to the particular embodiments of the process, machine, manufacture, composition of matter, means, methods and steps described in the specification.

1. An apparatus comprising:
a housing comprising a plurality of apertures, the plurality of apertures defining at least one air inlet and at least one air outlet;
a guard disposed proximate a first end of the housing, wherein the at least one air inlet and the at least one air outlet are disposed between the guard and a second end of the housing opposite the first end;
a motor within the housing comprising a first end and a second end, the motor further including at least one air intake aperture and at least one air exhaust aperture, wherein the first end of the motor is disposed between the first end of the housing and the guard;
a working tool disposed between the first end of the housing and the guard, wherein the working tool is in mechanical communication with the motor, and wherein the working tool is driven by the motor via the mechanical communication in response to a control signal; and at least one protected air channel in fluid communication with the first end of the motor for directing cooling air thereto.

2. The apparatus of claim 1, further comprising:
a motor mount disposed within the housing and defining the at least one protected air channel; and
a fan disposed within the housing and configured to draw cooling air into the housing via the at least one air inlet, wherein at least a portion of the cooling air is directed to the at least one protected air channel to cool the motor, and wherein the cooling air exits the motor via the at least one air exhaust aperture and exits the housing via the at least one air outlet.

3. The apparatus of claim 2, wherein the fan is a centrifugal fan disposed within the motor.

4. The apparatus of claim 2, wherein the motor mount comprises:
a plurality of ribs configured to engage an exterior of the motor, wherein the at least one protected air channel is disposed between a first rib of the plurality of ribs and a second rib of the plurality of ribs; and
at least one exhaust cap configured to direct air exiting the at least one air exhaust aperture to the at least one air outlet.

5. The apparatus of claim 4, wherein the at least one exhaust cap comprises a first exhaust cap and a second exhaust cap, the first exhaust cap disposed between a first pair of ribs of the plurality of ribs and the second exhaust cap disposed between a second first pair of ribs of the plurality of ribs, wherein a second protected air channel is disposed between the first exhaust cap and the second exhaust cap.

6. The apparatus of claim 2, wherein the motor mount defines at least one additional protected air channel.

7. The apparatus of claim 1, wherein the at least protected one air channel is configured to direct the cooling air over an exterior surface of the motor upon entering the housing prior to the cooling air entering the motor via the at least one air intake aperture.

8. The apparatus of claim 1, wherein the at least one air intake aperture includes a first air intake aperture and a second air intake aperture, the first air intake aperture disposed at the first end of the motor and the second air intake aperture disposed at the second end of the motor, wherein the first air intake aperture and the second air intake aperture are in fluid communication with the at least one protected air channel for directing cooling air into the motor, and wherein the at least one air exhaust aperture is disposed on a side of the motor and in fluid communication with the at least one air outlet.

9. The apparatus of claim 1, wherein the at least one exhaust cap is configured to seal a space between the at least one air exhaust aperture and the at least one air outlet from an interior of the housing.

10. The apparatus of claim 1, further comprising a printed circuit board (PCB) disposed within the housing, wherein the cooling air is configured to cool the PCB.

11. The apparatus of claim 1, wherein the guard defines a guard air intake in fluid communication with the at least one protected air channel.

12. The apparatus of claim 11, wherein the guard air intake is disposed on a first side of the guard, wherein the working tool is disposed on a second side of the guard, and wherein the second side of the guard faces the working tool.

13. The apparatus of claim 12, wherein the guard air intake is not accessible from the second side of the guard.

14. The apparatus of claim 11, further comprising a second guard air intake.

15. The apparatus of claim 11, wherein the at least one air inlet comprises a first air inlet, the at least one air intake aperture comprises a first air intake aperture disposed at the first end of the motor, and the first air inlet is adjacent to the first air intake aperture.

16. The apparatus of claim 15, wherein the at least one air inlet further comprises a second air inlet, the at least one air intake aperture further comprises a second air intake aperture disposed at the second end of the motor, and the second air inlet is adjacent to the second air intake aperture.

17. The apparatus of claim 15, wherein the at least one protected air channel guides cooling air from the guard air intake to the first air inlet.

18. The apparatus of claim 16, wherein the guard air intake is aligned with the first air inlet, and wherein the second air inlet and the at least one air outlet are disposed between the guard and a second end of the housing opposite the first end.

19. The apparatus of claim 1, further comprising at least one exhaust cap configured to direct air exiting the at least one air exhaust aperture to the at least one air outlet.

20. The apparatus of claim 1, wherein the working tool is selected from a group consisting of at least one tine disk, a disc brush, a saw blade, or an auger bit.
